(19) United States
(12) Patent Application Publication
(10) Pub. No.: US 2003/0115141 A1
(43) Pub. Date: Jun. 19, 2003

(54) Electronic account data or transactions routing system

(76) Inventors: June Y. Felix, New York, NY (US); Ronald A. Braco, New York, NY (US); Kathryn V. Lawton, New York, NY (US); Lee A. Feinberg, West Field, NJ (US); Catherine MacArthur, Milburn, NJ (US); William Rykowsky, S. Setauket, NY (US)

Correspondence Address: DICKSTEIN SHAPIRO MORIN & OSHINSKY LLP, Michael J. Scheer, 41st Floor, 1177 Avenue of the Americas, New York, NY, 10036-2714, US

(21) Appl. No.: 10/336,495

(22) Filed: Jan. 2, 2003

Related U.S. Application Data
(63) Continuation of application No. 09/241,043, filed on Feb. 1, 1999.
(60) Provisional application No. 60/115,925, filed on Jan. 14, 1999.

(51) Int. Cl. G06F 17/60

(52) U.S. Cl. 705/40

(57) ABSTRACT

A system for routing electronic account data, includes: a first provider of account services having a first user service provider for communicating account data initiated from a first set of users and a first customer service provider for communicating the account data with a first set of customers; a second provider of account services having a second user service provider for communicating account data initiated from a second set of users and a second customer service provider for communicating the account data with a second set of customers; and an electronic account exchange system communicating with the first and second user service providers and the first and second customer service providers, the electronic account exchange system being operable to permit one or more of the first set of users to communicate its account data with one or more of the second set of customers.

### CROSS REFERENCE TO RELATED APPLICATION

This application is based on and claims priority to U.S. Provisional Patent Application No. 60/115,925, filed Jan. 14, 1999, entitled ELECTRONIC ACCOUNT DATA OR TRANSACTIONS ROUTING SYSTEM, the entire disclosure of which is incorporated herein by reference.

### BACKGROUND OF THE INVENTION

1. Field of the Invention

The present invention relates to electronic presentment of financial statements from one party to another party over a network and, more particularly, to a system in which service providers create a network for connecting a plurality of providers of goods or services with a plurality of customers such that account data, financial statements, and/or transactional information may be electronically transmitted over the network.

2. Related Art

The electronic presentment of bills from a party who provides goods and services to a customer of that party is becoming increasingly important. Indeed, the costs associated with providing hard copy bills through the mails is becoming increasingly costly and, therefore, it is becoming more attractive for a billing party to electronically deliver its bills to its customers. Similarly, as customers become more technologically advanced, the customers are likely to demand that bills be provided in an electronic form.

Referring now to FIGS. 1a and 1b, it is possible to provide electronic bills from a billing party 16 to a customer 18. A conventional electronic billing system 10 includes a billing service provider 12 and a customer service provider 14. The billing service provider 12 may be, for example, a bank which enters into agreements with one or more billing parties 16 to provide billing information in electronic form to customers 18 of the billing parties 16.

The billing service provider 12 typically contracts with the customer service provider 14 to transfer the electronic billing information from the billing service provider 12 to one or more customers 18.

As is known in the art, the customer service provider 14 may provide a branded website on the internet which the customers 18 may access. The branded website, although maintained and controlled by the customer service provider 14, can exhibit at least some billing party specific information such that it looks as if being provided by the billing party 16 who initiated the bill for the customer 18. Thus, from the customer's 18 standpoint, the branded website provided by the customer service provider 14 appears to be provided directly from the billing party 16.

In some circumstances, the billing service provider 12 may itself be capable of providing customer service and, therefore, act as both a billing service provider 12 and a customer service provider 14. For example, as shown in FIG. 1a, customers 3 and 4 may access, for example, a website provided by the billing service provider 12 on which to receive billing information from one of the billing parties 16.

Unfortunately, not all customers 18 subscribe to the electronic billing system 10 shown in FIG. 1a. Indeed, some customers 18 may subscribe to a different electronic billing system 20. The electronic billing system 20 may include a billing service provider 22 and a customer service provider 24. Thus, a billing party 16 (such as biller 1) may be required to subscribe to both billing service provider 12 and billing service provider 22 in order to access more of its customers 18. In particular, biller 1 may desire to present electronic bills to both customer 1 and customer 5. Since customer 1 subscribes only to electronic billing system 10 and customer 5 subscribes only to electronic billing system 20, biller 1 must subscribe to the services of both billing service provider 12 and billing service provider 22.

Similarly, a particular customer 18 may desire to receive electronic bills from more than one billing party 16 and, therefore, may be required to subscribe to more than one customer service provider (14, 24). For example, customer 2 may desire to receive electronic bills from biller 2 and biller 3. Accordingly, as biller 2 only subscribes to billing service provider 12 and biller 3 only subscribes to billing service provider 22, customer 2 must subscribe to both customer service provider 14 and customer service provider 24 to receive electronic bills from both biller 2 and biller 3.

Accordingly, there is a need in the art for a new electronic billing system which is capable of networking a larger number of billing parties with customers which does not require a particular billing party to contract with numerous billing service providers and also does not require a particular customer to contract with numerous customer service providers.

### SUMMARY OF THE INVENTION

In order to overcome the disadvantages of the prior art, the present invention includes a system for routing electronic account data, comprising:

a first provider of account services having a first user service provider for communicating account data initiated from a first set of users, and a first customer service provider for communicating the account data with a first set of customers,

a second provider of account services having a second user services provider for communicating account data initiated from a second set of users, and a second customer service provider for communicating the account data with a second set of customers; and

an electronic account exchange system communicating with the first and second user service providers and the first and second customer service providers, the electronic account exchange system being operable to permit one or more of the first set of users to communicate its account data with one or more of the second set of customers.

According to another aspect of the present invention, a system for routing electronic account data, includes:

a first provider of account services having a first billing service provider for communicating bills initiated from a first set of billing parties, and a first customer service provider for communicating the bills to a first set of customers;

a second provider of account services having a second billing service provider for communicating bills initiated from a second set of billing parties, and a second customer service provider for communicating the bills to a second set of customers; and

an electronic bill exchange system communicating with the first and second billing service providers and the first and second customer service providers, the electronic bill exchange system being operable to permit the first and second providers of account services to communicate settlement information which includes amounts of funds released by at least one of the customer service providers to pay bills on behalf of one or more customers for whom the one or more customer service providers does not hold a financial account.

Other objects, features and advantages of the invention will be apparent to those skilled in the art from the description of the invention as presented hereinbelow with reference to the accompanying drawing.

### BRIEF DESCRIPTION OF THE DRAWING

For the purpose of illustrating the invention, there is shown in the drawing a form which is presently preferred, it being understood, however, that the invention is not limited to the precise arrangement and instrumentality shown.

FIGS. 1a and 1b are block diagrams illustrating an electronic billing system according to the prior art;

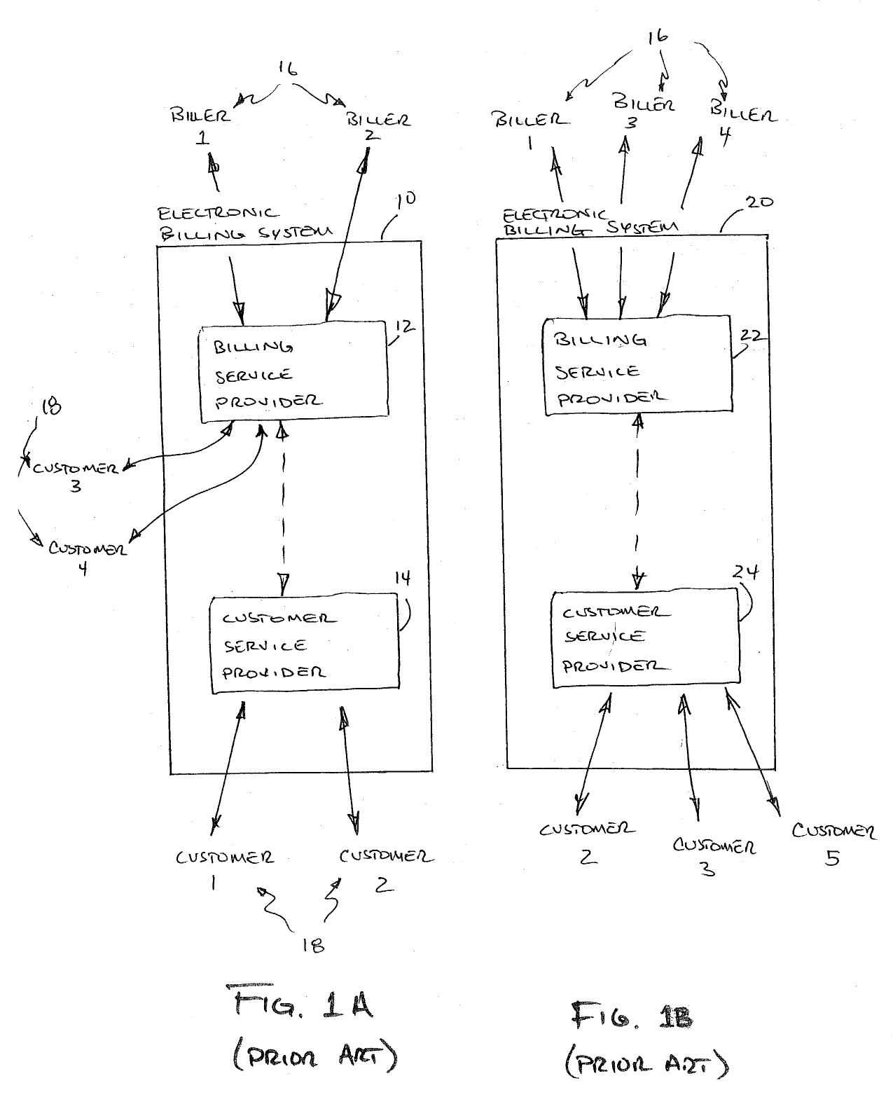

FIG. 2 is a block diagram illustrating an electronic billing system according to the present invention;

FIG. 3 is a block diagram illustrating the components included in the electronic bill exchange system of the present invention;

FIG. 4 is a flow diagram illustrating the control sequence employed by the present invention for billing requests;

FIG. 5 is a flow diagram illustrating the control sequence employed by the present invention for bill payment; and

FIG. 6 is a flow diagram illustrating the control sequence employed by the present invention for customer enrollment.

### DETAILED DESCRIPTION OF THE INVENTION

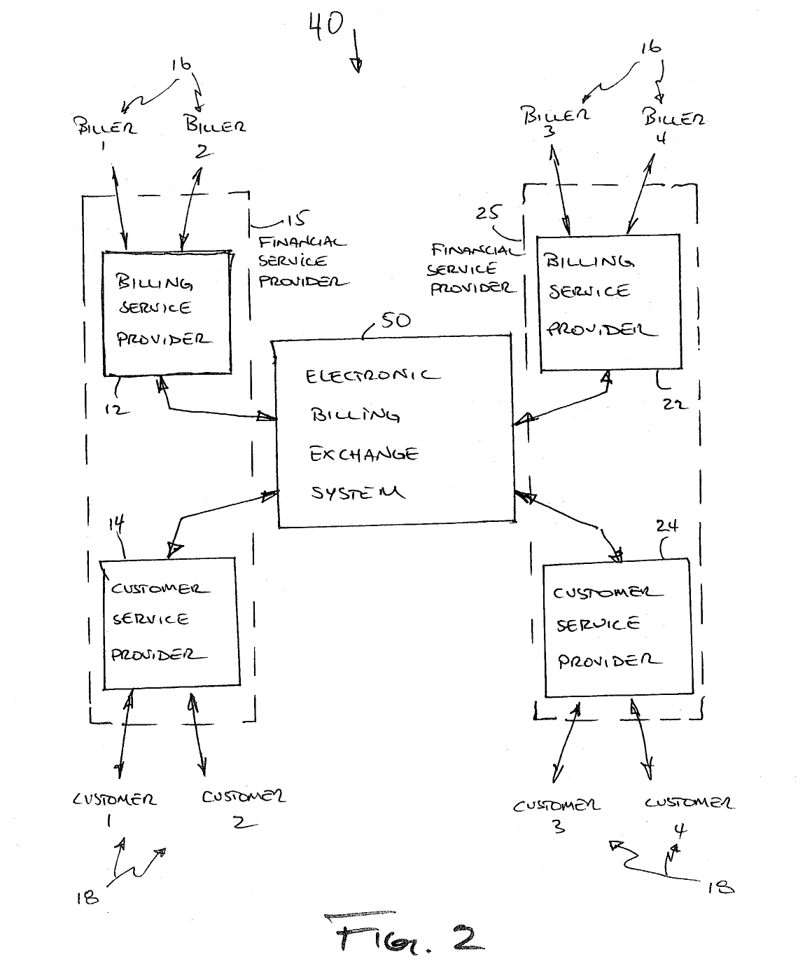

Referring now to the drawing wherein like numerals indicate like elements, there is shown in FIG. 2 an electronic account data or transactions routing system 40 in accordance with the present invention. For the purposes of illustrating the invention, the electronic account data or transactions routing system 40 is discussed in terms of presenting bills from a plurality of billing parties 16 (biller 1, biller 2, biller 3, etc.,) to a plurality of customers 18 (customer 1, customer 2, customer 3, etc.). The billing parties 16 may represent the providers of goods and services utilized by the customers 18, for example, telephone providers, utility providers, food services providers, credit services providers, etc.

Those skilled in the art will recognize that the electronic account data or transactions routing system 40 of the present invention is not limited to providing bills from billing parties to customers, but rather may be extended to providing electronic account information relating to other services, for example, financial information (such as credit history, invoices and/or trade transactions), marketing information (such as unique customer information obtained from value added marketing, cookies, e.g., java programs), financial securities information (including 401(k) data, proxy statements, prospectuses, etc.), government related information (including tax reporting data, social securities financial data, medicare data, etc.), medical information, insurance account information, other business information (for example, airline ticketing—scheduling—purchasing data, etc.).

The electronic account data or transactions routing system 40 of the present invention includes one or more billing service providers 12, 22 and one or more customer service providers 14, 24 defining a network through an electronic bill exchange system 50. While only two billing service providers 12, 22 and two customer service providers 14, 24 are shown, any number may be employed without departing from the scope of the invention.

Those skilled in the art will recognize that, the term “billing” is used in this example of the invention to define the parties 16, the service providers 12, 22 and the service providers 14, 24 because the example concerns the presentation and/or payment of bills. Of course, the parties 16, and the service providers 12, 22 and 14, 24 may be defined in other ways when the electronic account data or transactions routing system 40 is used in the other contexts listed above.

In this example of the invention, billing service provider 12 and customer service provider 14 are preferably related entities within a financial services provider 15, such as a bank. Similarly, it is preferred that billing service provider 22 and customer service provider 24 are related within a financial services provider 25 (for example, another bank). In forming the network, financial services provider 15 and financial services provider 25 jointly agree to exchange billing information related to the plurality of billing parties 16 and customers 18. Once the agreement is in place, the billing information may flow from a particular billing party 16 to any one of the customers 18 through the electronic bill exchange system 50.

As will be described below in more detail, the electronic bill exchange system 50 permits, for example, customer service provider 14 to request billing information from one or more of the billing parties 16 of billing service provider 22 even though it is not otherwise associated with billing service provider 22. Thus, a bill may be presented from, for example, biller 3 to customer 1.

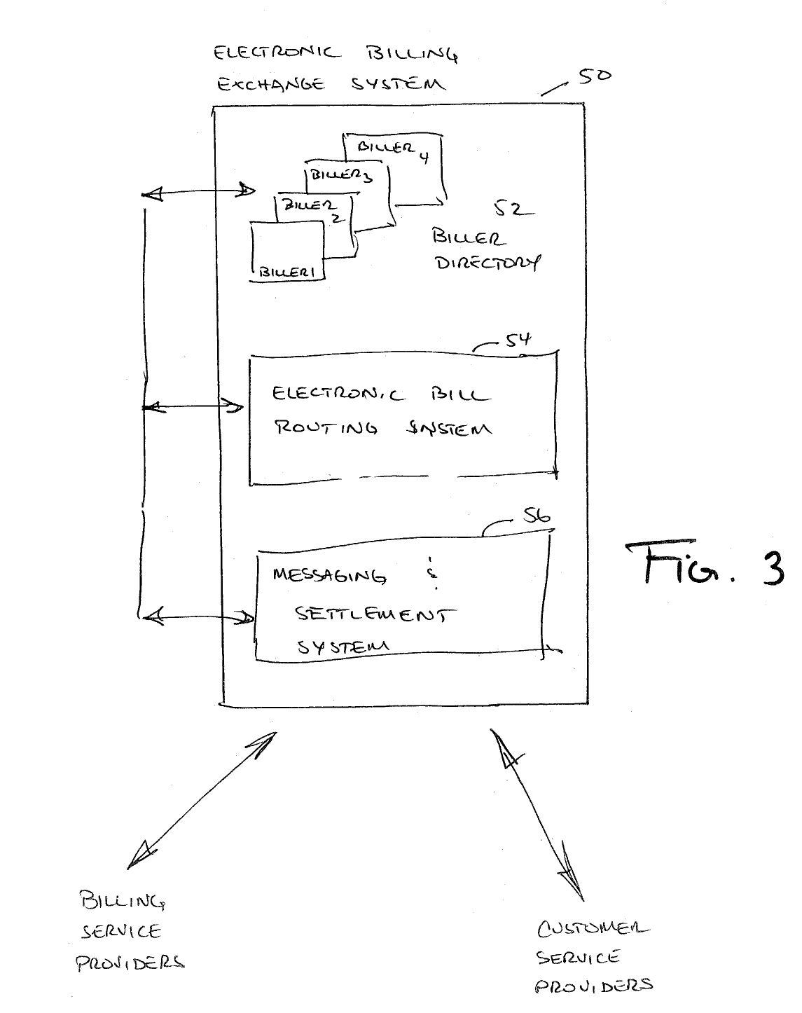

Reference is now made to the block diagram of FIG. 3 which illustrates the components of the electronic bill exchange system 50. In particular, the electronic bill exchange system 50 includes a biller directory 52, an electronic bill routing system 54, and a messaging and settlement system 56.

The biller directory 52 includes details on the billing parties 16 subscribing to the network through the billing service providers 12, 22. The details on each billing party 16 contained in the biller directory 52 include the names of the billing service provider for the billing party 16 and the customer service providers subscribing to the routing system 40. Among other things, the biller directory 52 facilitates cross referencing when billing information requests are made. Table 1 provides an example of other types of information included in each record contained in the biller directory 52.

TABLE 1

Biller Directory:
Biller Identifier;
Biller Name;
Customer service contact information (name, address,
customer support contact);
Payment mechanism information (payment instruments
accepted, remittance (name and address) ;
Presentation information (bill-specific information,
URL address, biller's logo or trademark, biller's
enrollment requirements);
Account information (account format etc.);
Billing service provider routing information (used for
routing requests);
Biller's remittance information

Those skilled in the art will appreciate from the above that the electronic bill routing system 54 provides the function of receiving electronic billing information from and delivering the electronic billing information to any of the billing service providers 12, 22 and customer service providers 14, 24 in accordance with stored or dynamic routing information. Preferably, the routing information is obtained from the biller directory 52. Any of the known hardware and software solutions may be employed to obtain the necessary functions of the electronic bill routing system 54. For example, known servers, routers and data bases may be employed which operate under the control of known software programs.

Those skilled in the art will understand that the electronic bill exchange system 50 provides the requisite platform for facilitating messaging and settlement functions utilizing any of the known hardware and software solutions. As all of the billing services providers 12, 22 and customer service providers 14, 24 are linked through the electronic bill exchange system 50, the messaging and settlement system 56 can readily facilitate the communications necessary to transfer electronic information over the routing system 40 such that messaging and settlement between (i) the billing service providers 12, 22 and customer service providers 14, 24; and/or (ii) the financial service providers 15, 25 is obtained.

The messaging and settlement system 56 preferably includes a means for providing settlement information between (i) the customer service providers 14, 24; the billing service providers 12, 22; and/or the financial service providers 15, 25. Advantageously, such settlement information is more quickly provided between the above listed entities through the electronic billing and exchange system 50 and, thus, settlement instruments (such as money) may be more quickly routed between the entities to settle any outstanding accounts. The process of settlement through the electronic billing and exchange system 50 will be discussed in terms of an example hereinbelow.

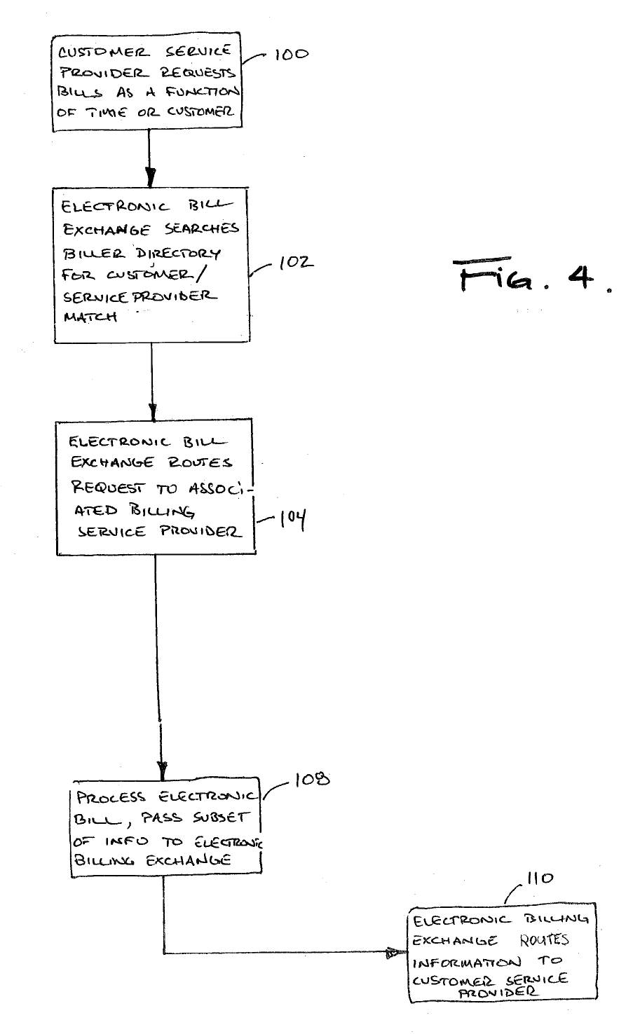

Reference is now made to the flow diagram of FIG. 4 which illustrates the control sequence utilized by the electronic account data or transactions routing system 40 to facilitate bill presentment and payment between any of the billing parties 16 and customers 18. At step 100, a particular customer service provider, for example customer service provider 14, requests bills from the electronic bill exchange system 50 as a function of a particular time period and/or one or more of its customers 18. For example, the customer service provider 14 may request all outstanding bills for customer 1. Alternatively, the customer service provider 14 may request bills for all of its customers 18 during a particular time period, for example, a specified month or day. Those skilled in the art from the above teaching will understand that many permutations in specifying customers and/or time periods exist which fall within the scope of the invention.

The electronic bill exchange system 50 receives the request from the customer service provider 14 at step 102 and searches the biller directory 52 for the billing services providers which correspond with the requested bills. At step 104, the electronic bill exchange system 50 routes the request from the customer service provider 14 to the associated billing service provider, for example billing service provider 22, that hold bills for the customer service provider 14.

At step 106, the particular billing service provider (here, billing service provider 22), may already possess all billing information necessary to process the billing request made by the customer service provider 14. In the event that the billing service provider 22 requires more information from one or more of the billing parties 16 to process the billing request, it may obtain same at step 106.

When the billing service provider 22 is in possession of the requisite billing information to process, for example an electronic bill, it processes the electronic bill and passes at least a subset of information relating to the electronic bill to the electronic bill exchange system 50 for routing to the customer service provider 14 (steps 108 and 110).

It is preferred that the billing service provider 22 include an electronic address with the billing information at step 108 which identifies an electronic location where the detailed billing information may be found and/or viewed. For example, when the detailed billing information may be obtained over the internet, it is preferred that the billing service provider 22 provide a URL address with the subset of information relating to the electronic bill to the electronic bill exchange system 50 for delivery to the customer service provider 14. Thus, a particular customer 18 may access the URL provided by the billing service provider 22 to review the details of the subject electronic bill.

It is noted that a detailed electronic bill may include such information as a billing party name and address, customer service contact information, detailed customer account information, a customer name and address, a detailed description of goods and service provided, customer account payment information, the billing party's billing service provider information, advertising, etc. When the customer service provider 14 requests billing information, however, all of the electronic bill information need not be transmitted. Indeed, only a subset of the detailed information need be transmitted to the customer service provider 14, such as the customer name, total remittance, URL address, etc.

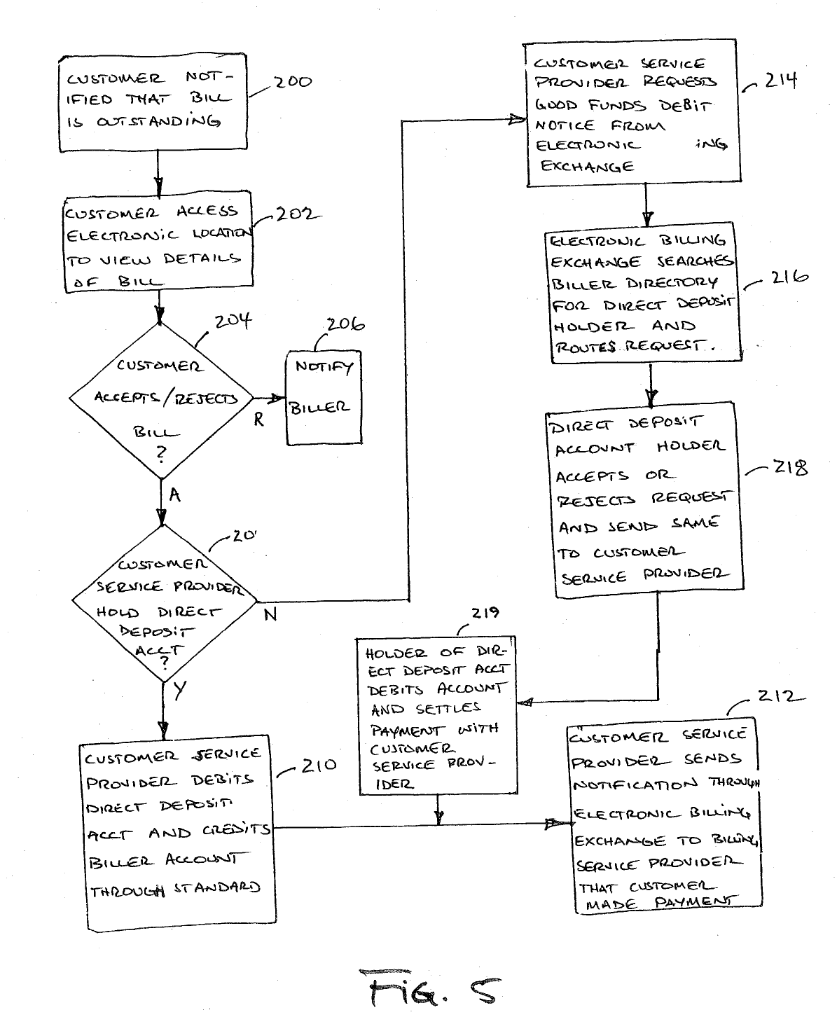

Reference is now made to the flow diagram of FIG. 5 which illustrates the control flow utilized by the electronic account data or transactions routing system 40 when bill payment is carried out. At step 200, a particular customer 18 is notified by its customer service provider 14 that a bill is outstanding. This notification may take the form of a brief message indicating the billing party 16 and the total remittance due. It is preferred that the notification take place on an information network such as the internet. When the internet is utilized to notify the customer 18 of an outstanding bill, the URL address provided by the billing service provider 22 is included with the notification, thereby permitting the customer 18 to access the electronic location (the URL address) to view the details of the outstanding bill (step 102).

When the customer 18 has reviewed the details of the bill, for example, the details of the goods and services provided and the total remittance for those goods and services, the customer 18 may accept or reject the bill (step 204). If the customer 18 rejects the bill, then at step 206 the billing party 16 is notified through the electronic account data or transactions routing system 40.

If the customer 16 accepts and wishes to pay the bill (step 204), then the customer 18 notifies and instructs the customer service provider 14 to make the appropriate financial transactions to pay the bill. Preferably, this is accomplished by providing the customer 18 with a trigger or activator (e.g., a phone DTMF code, an electronic code, etc.) which, when activated, indicates the customer's 18 desire to pay the bill. It is most preferred to provide the customer with an ICON located at the internet screen which indicates that payment is desired.

It is noted that the trigger may be presented to the customer 18 when the customer service provider 14 presents the subset of billing information to the customer 18 (i.e., at step 200). Advantageously, a customer 18 need not view all of the details of the bill prior to making payment, rather he or she may initiate payment only having received a notification from the customer service provider 14 that a bill is outstanding.

Those skilled in the art understand that there are a plurality of methods to pay a billing party 16 for goods and services (for example, by debiting a financial account, by credit card, etc.). These methods are usually established by the billing parties 16 and agreed to when a customer 18 enrolls in the system. Steps 208-219 illustrate the specific procedures for paying a bill by debiting a direct deposit account, it being understood that other methods of payment are available without departing from the scope of the invention.

At step 208, it is determined whether the customer service provider 14 is the holder of a direct deposit account for the particular customer 18 desirous of making payment on the electronic bill. If the customer service provider 14 is the holder of the direct deposit account for the customer 18, then process flow transfers to step 210. If the customer service provider 14 is not the holder of the direct deposit account for the customer 18, control proceeds to step 214.

At step 210, the customer service provider 14 simply debits the customer's 18 direct deposit account and credits the biller's 16 account through established payment channels and processes. At step 212, the customer service provider 14 sends a notification (including financial reconciliation information) to the billing service provider 22 through the electronic bill exchange system 50 which indicates that the customer 18 accepted the bill and made a payment. Thus, among other things, when the customer service provider 14 next requests bills from the billing service provider 22, paid bills may be omitted.

When the customer service provider 14 is not the holder of the customer's 18 direct deposit account, the customer service provider 14 sends a request for a so-called good funds debit notice to the electronic bill exchange system 50 (step 214). In essence, a good funds debit notice indicates whether a customer 18 has adequate funds to cover a particular transaction and whether that customer 18 is in good standing with the holder of the direct deposit account.

At step 216, the electronic bill exchange system 50 searches the billing directory 52 for the direct deposit account holder for the customer 18 and routes the request for the good funds debit notice to the billing service provider associated with the direct deposit account holder At step 218, the direct deposit account holder prepares the good funds debit notice and sends the same to the customer service provider 14 through the electronic bill exchange system 50. Process flow then is transferred to step 219 where the customer's 18 direct deposit account is debited by the holder of the direct deposit account.

It is noted that the customer service provider 14 may temporarily provide the funds to pay the billing party 16 even though it is not the holder of the customer's 18 direct deposit account. Subsequently, when the holder of the direct deposit account debits the customer's direct deposit account (step 219), the customer service provider 14 will be reimbursed for the payment (i.e., a settlement will occur which is substantially similar to settlements which occur in ATM transactions).

Advantageously, the electronic account data or transactions routing system 40 is capable of connecting and paying on accounts between billing parties 16 and customers 18, where a customer 18 is associated with a customer service provider (e.g., customer service provider 14) who does not hold that customer's 18 direct deposit account to be debited.

It is noted that the above-mentioned settlements between, for example: (i) the holder of a customer's 18 direct deposit account and that customer's customer service provider 14; or (ii) financial service providers 15, 25, may be facilitated via the electronic account data or transactions routing system 40.

In particular, for a settlement to occur, a service provider who has paid a billing party 16 on behalf of a customer 18 and who does not hold that customer's direct deposit account (for example, financial service provider 15) must exchange settlement information with a service provider who holds that customer's direct deposit account (for example, financial service provider 25). This settlement information includes the payment amount(s) that service provider 25 owes service provider 15. The settlement information may also include amounts of funds released, identities of the customers for whom bills have been paid, identities of customer service providers holding the respective debit accounts for the customers for whom bills have been paid.

The settlement information between service providers may be exchanged over the electronic bill exchange system 50 by means of, for example, the messaging and settlement system 56, provided that both service providers 15, 25 are part of the network.

Any of the one or more customer service providers 14, 24 who release funds to pay bills on behalf of respective customers 18 for whom they do not hold direct deposit accounts (or debit accounts) may communicate settlement information over the electronic bill exchange system 50 during a single transmission, where the settlement information includes (i) more than one amount of funds released, (ii) more than one customer, and (iii) more than one identity of customer service provider holding a debit account for a customer for whom a bill has been paid.

Thus, the customer service providers 14, 24 need not transmit settlement information each time they release funds on behalf of a customer 18 for whom they do not hold a debit account. Rather, the customer service providers 14, 24 may combine settlement information for all such released funds during a particular period (e.g., a day) and transmit the information once to the electronic bill exchange system 50. The electronic bill exchange system 50 is operable to automatically route subsets of the combined settlement information to respective service providers 15, 25 holding debit accounts for the customers for whom bills have been paid.

Once the settlement information has been exchanged between service providers 15, 25, service provider 25 may release funds sufficient to cover the amount owed to provider 15 through the Federal Reserve as is well known in the art. It is preferred that settlement between service providers occur on a substantially regular basis (e.g., daily).

Advantageously, settlement information may be exchanged between service providers by way of the single network of the present invention without requiring a plurality of networks between two or more service providers as is the case in the prior art.

As discussed above, other methods of paying the bill are within the scope of the invention. For example, when the customer 18 pays a bill using a credit account (e.g., using a credit card), then the customer service provider 14 causes the customer's 18 credit card account to be debited any payment made to the respective billing party 16 by way of well known credit card channels.

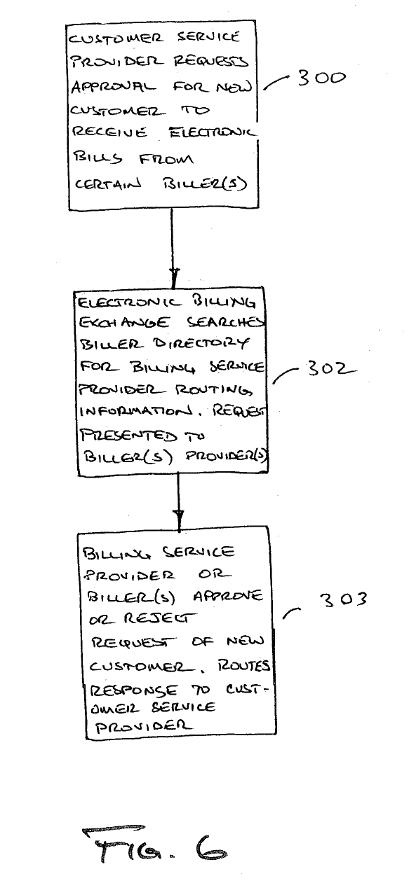

Reference is now made to FIG. 6 which illustrates the process flow utilized by the electronic bill exchange system 50 when a potential new customer 18 is desirous of receiving electronic bills through the electronic account data or transactions routing system 40. At step 300, the customer service provider of the potential new customer 18 requests approval to receive electronic bills from one or more of the billing parties 16. The electronic bill exchange system 50 searches the billing directory 52 for billing service providers associated with the subject billing parties 16 and presents the request for approval to the billing service provider(s) (step 302). If the billing parties 16 approve the request of the new customer, the customer service provider(s) are notified through the billing service provider(s) and the billing directory 52 is appropriately updated (step 303).

Advantageously, a particular billing party 16 need only associate itself with a single billing service provider to gain access to all of the customers 18 on the network. Similarly, a particular customer 18 need only subscribe to one customer service provider to facilitate receiving electronic bills from any of the billing parties 16 subscribing to the electronic account data or transactions routing system 40.

Although the present invention has been described in relation to a particular embodiment thereof, many other variations and modifications and other uses will become apparent to those skilled in the art. It is preferred, therefore, that the present invention be limited not by the specific disclosure herein, but only by the appended claims.

We claim:

1. A system for routing electronic account data, comprising:
a first provider of account services having a first user service provider for communicating account data initiated from a first set of users, and a first customer service provider for communicating the account data with a first set of customers;
a second provider of account services having a second user service provider for communicating account data initiated from a second set of users, and a second customer service provider for communicating the account data with a second set of customers; and
an electronic account exchange system communicating with the first and second user service providers and the first and second customer service providers, the electronic account exchange system receiving account data from one or more of the user service providers and routing the received account data to one or more of the customer service providers.

2. The system of claim 1, wherein the electronic account exchange system is operable to permit one or more of the second set of users to communicate its account data with one or more of the first set of customers.

3. The system of claim 1, further comprising three or more providers of account services each having a user service provider for communicating account data initiated from a distinct set of users, and a customer service provider for communicating the account data with a distinct set of customers, wherein the electronic account exchange system is operable to permit any user to communicate its account data with any customer.

4. The system of claim 3, wherein the electronic account exchange system includes an electronically searchable user directory operable to provide an index for linking the user service providers with the customer service providers.

5. The system of claim 4, wherein the user directory includes, for each user, at least one of a user identifier, a user name, user customer service contact information, account payment information, account presentment information, user routing information, and remittance information.

6. The system of claim 5, wherein the user identifier includes an alpha-numeric code.

7. The system of claim 5, wherein the user customer service contact information includes at least one of a name, an address, a phone number, a facsimile number, a URL address, and an electronic mail address.

8. The system of claim 5, wherein the account payment information includes at least one of a mechanism for account payment, payment instruments accepted, and remittance details.

9. The system of claim 5, wherein the account presentment information includes at least one of an electronic address at which detailed account information may be found, a user business identifier, and enrollment requirements.

11. The system of claim 3, wherein
the account data represent bills initiated by billing parties who provide goods or services to the customers;
the user service providers are billing service providers; and
the providers of account services are banks which include respective billing service providers and customer service providers.

12. The system of claim 11, wherein any of the customer service providers is operable to request billing information for presentment to one or more of its customers as a function of at least one of a specified time period and a specified customer.

13. The system of claim 12, wherein the electronic account exchange system is operable to route the request to respective billing service providers as a function of at least one of the specified time period and the specified customer.

14. The system of claim 13, wherein the respective billing service providers are operable to provide at least a subset of the billing information initiated from respective billing parties to the one or more customer service providers requesting the billing information via the electronic account exchange system.

15. The system of claim 14, wherein the subset of the billing information includes an electronic address at which the billing information may be viewed by the respective customer.

16. The system of claim 15, wherein the electronic address is an internet URL address.

17. The system of claim 15, wherein the customer service providers are operable to notify the respective customers to which the billing information is directed that payments on the respective bills are required by presenting the subset of billing information.

18. The system of claim 17, wherein the customer service providers are operable to provide the respective customers an activator which is capable of indicating that the customer desires to electronically pay the bill.

19. The system of claim 15, wherein an activator is provided at the electronic address at which the customer may view the billing information, which activator is capable of indicating that the customer desires to electronically pay the bill.

20. The system of claim 19, wherein the customer service provider is operable to execute payment of the bill when the customer executes the activator.

21. The system of claim 20, wherein the customer service provider need not be a holder of a financial account of the customer to execute payment of the bill.

22. A system for routing electronic account data, comprising:
a first provider of account services having a first billing service provider for communicating bills initiated from a first set of billing parties, and a first customer service provider for communicating the bills to a first set of customers;
a second provider of account services having a second billing service provider for communicating bills initiated from a second set of billing parties, and a second customer service provider for communicating the bills to a second set of customers; and
an electronic bill exchange system communicating with the first and second billing service providers and the first and second customer service providers, the electronic bill exchange system routing settlement information among the first and second billing service providers and the first and second customer service providers, the settlement information including amounts of funds released by at least one of the customer service providers to pay bills on behalf of one or more customers for whom the one or more customer service providers does not hold a financial account.

23. The system of claim 22, wherein the settlement information is communicated over the electronic bill exchange system periodically.

24. The system of claim 23, wherein the settlement information is communicated over the electronic bill exchange system on a daily basis.

25. The system of claim 22, wherein the settlement information includes (i) amounts of funds released, (ii) identities of the customers for whom bills have been paid, (iii) identities of customer service providers holding the respective financial accounts for the customers for whom bills have been paid.

26. The system of claim 25, wherein at least one of the customer service providers who release funds to pay bills on behalf of respective customers may communicate settlement information over the electronic bill exchange system during a single transmission concerning at least one of (i) more than one amount of funds released, (ii) more than one customer, and (iii) more than one identity of customer service provider holding a financial account for a customer for whom a bill has been paid.

27. The system of claim 26, wherein the electronic bill exchange system is operable to route subsets of the settlement information to respective service providers holding financial accounts for the customers for whom bills have been paid.

28. A method of routing electronic account data, comprising the steps of
a) initiating account data from a user among a plurality of sets of users and communicating the account data to a respective user service provider among a plurality of user service providers, each associated with a set of users;
b) communicating the account data to an electronic account exchange system for linking the user service providers with a plurality of customer service providers, each customer service provider being associated with a respective set of customers;
c) routing the account data from the user service provider to any one of the customer service providers based on routing criteria; and
d) communicating the account data from the customer service provider to a customer from among the plurality of sets of customers, such that any of the users is capable of communicating account data to any of the customers.

29. The method of claim 28, further comprising the step of obtaining the routing criteria by searching an electronically searchable user directory associated with the electronic account exchange system, the directory for providing an index for linking the user service providers with the customer service providers.

30. The method of claim 29, wherein the user directory includes, for each user, at least one of a user identifier, a user name, user customer service contact information, account payment information, account presentment information, user routing information, and remittance information.

31. The method of claim 30, wherein the user identifier includes an alpha-numeric code.

32. The method of claim 30, wherein the user customer service contact information includes at least one of a name, an address, a phone number, a facsimile number, a URL address, and an electronic mail address.

33. The method of claim 30, wherein the account payment information includes at least one of a mechanism for account payment, payment instruments accepted, and remittance details.

34. The method of claim 30, wherein the account presentment information includes at least one of an electronic address at which detailed account information may be found, a user business identifier, and enrollment requirements.

35. The method of claim 30, wherein the electronic account exchange system includes an electronic account routing system operable to direct the account data between one or more of the user service providers and one or more of the customer service providers based on the information contained in the user directory.

36. The method of claim 28, wherein
the account data represent bills initiated by billing parties who provide goods or services to the customers;
the user service providers are billing service providers; and
the providers of account services are banks which include respective billing service providers and customer service providers.

37. The method of claim 36, wherein any of the customer service providers is operable to execute the step of requesting billing information for presentment to one or more of its customers as a function of at least one of a specified time period and a specified customer.

38. The method of claim 37, further comprising the step of routing the request to respective billing service providers using the electronic account exchange system as a function of at least one of the specified time period and the specified customer.

39. The method of claim 38, further comprising the step of providing at least a subset of the billing information initiated from respective billing parties to the one or more customer service providers requesting the billing information via the respective billing service providers and the electronic account exchange system.

40. The method of claim 39, wherein the subset of the billing information includes an electronic address at which the billing information my be viewed by the respective customer.

41. The method of claim 40, wherein the electronic address is an internet URL address.

42. The method of claim 40, further comprising the step of presenting the subset of billing information to the respective customers to which the billing information is directed via the customer service providers.

43. The method of claim 40, wherein an activator is provided at the electronic address at which the customer may view the billing information, which activator is capable of indicating that the customer desires to electronically pay the bill.

44. The method of claim 43, further comprising the step of executing payment of the bill when the customer executes the activator via the customer service provider.

45. The method of claim 44, wherein the customer service provider need not be a holder of a financial account of the customer to execute payment of the bill.
